(19) United States
(12) Patent Application Publication
(10) Pub. No.: US 2014/0076815 A1
(43) Pub. Date: Mar. 20, 2014

(54) SEPARATION OF OIL DROPLETS FROM WATER

(71) Applicants: Khooi Yeei Tan, Coton (GB); Trevor Hughes, Cambridge (GB); Wilhelm Huck, Nijmegen (NL); Michaela Nagl, Cambridge (GB)

(72) Inventors: Khooi Yeei Tan, Coton (GB); Trevor Hughes, Cambridge (GB); Wilhelm Huck, Nijmegen (NL); Michaela Nagl, Cambridge (GB)

(73) Assignee: SCHLUMBERGER TECHNOLOGY CORPORATION, SUGAR LAND, TX (US)

(21) Appl. No.: 14/117,835

(22) PCT Filed: May 14, 2012
(86) PCT No.: PCT/IB2012/000941

§ 371 Date: Nov. 22, 2013

(30) Foreign Application Priority Data
May 18, 2011 (GB) 1108334.2

(51) Int. Cl. C02F 1/28

(52) U.S. Cl. CPC C02F 1/288
USPC 210/671; 210/691; 210/502.1

(57) ABSTRACT

A treatment process for an aqueous phase which contains oil droplets, possibly of 10-50 nm diameter, in aqueous flow from a hydrocyclone separator, comprises bringing the water into contact with a surface subdivided into areas of differing surface energy and affinity for oil and such that when the surface is submerged in an aqueous phase, oil droplets adhere to it with an apparent contact angle in a range from 90 to 150 degrees. Areas of the surface may reduce their affinity for oil in response to an external stimulus causing controlled release of droplets adhering to the surface. The process may be used to remove oil droplets from water produced by an oil or gas well, after downhole oil water separation or after production at a at a well head, or used to coalesce droplets in such water to a larger size to enable conventional separation.

### FIELD AND BACKGROUND

Embodiments of this invention relate to the separation of oil and water and to the separation of small droplets of oil from water.

Separation of oil and water is required in a number of areas of industry. Separation can be brought about by a mechanical separator, such as a hydrocyclone. This can separate a flowing mixture of oil and water into separate flows of oil and of water. However, the water which is separated from the oil generally contains very small droplets of oil. Diameter of such droplets is often under 100 micrometres, typically 10 to 50 micrometers. Because of their small size they are very slow to separate from water and it is very difficult to remove them. Addition of chemicals may be required to achieve separation.

Separation of oil and water may be required at various stages in the course of oil production and refining operations. It is sometimes desirable to carry out a separation of oil and water below ground, as oil and water flow together from a reservoir. The separated oil is directed towards the surface while the separated water (usually a saline solution) is reinjected into another part of the rock formations penetrated by the wellbore. If small oil droplets cannot be removed from the water before it is reinjected, they may adsorb onto the surfaces of the pores of the rock at or near the point of reinjection and reduce or block the porosity of the rock, thus reducing injectivity. However, separation of small droplets is even more difficult when working within the constraints of an underground location accessed by a wellbore. Nevertheless it may be desirable to carry out separation below ground, rather than bringing the oil and water together to the surface for separation.

If oil and water are produced together from a well, there may be a stringent requirement to remove oil before the separated water is reinjected or discharged. In these circumstances removal of small oil droplets can be a significant requirement.

Effective separation of oil and water may also be required in the context of separating oil from sea water after a spillage.

Separation of oil and water is thus an area where there is scope for further innovation.

### SUMMARY

One aspect of the subject matter disclosed herein provides a treatment process for water which contains oil droplets, the process comprising bringing the oily water into contact with a surface which is subdivided into areas of differing surface energy and hence also differing affinity for oil and which is such that when the surface is submerged in an aqueous phase, oil droplets adhere to it.

The areas of differing surface energy may be no more than 5 micrometer across and possibly no more than 1 micrometer across. They may possibly be at least 10 or at least 20 nanometers across. They may be a mixture of hydrophilic and hydrophobic areas. The properties and proportions of these areas will determine overall affinity for oil.

We have found that the presence of oleophilic (and therefore hydrophobic) areas can allow oil droplets to adhere to a surface, while the presence of hydrophilic areas can prevent the surface from being wetted overall by oil. If an oil droplet on the surface is larger than areas of the surface, and so is in contact with a number of areas of differing surface energy, the droplet will display a contact angle which results from contact with multiple areas of varying surface energy.

The overall affinity for oil may be such that when the surface is submerged in water or aqueous solution, adhering oil droplets may display a contact angle greater than 90°, such as in a range from 90° to 150°, possibly 110° to 150°.

Another aspect of the present subject matter provides a treatment process for water which contains oil droplets, the process comprising bringing the water into contact with a surface which is such that when the surface is submerged in water or aqueous solution, adhering oil droplets may display a contact angle greater than 90°, such as in a range from 90° to 150°, possibly 110° to 150°.

A surface on which oil droplets display a contact angle greater than 90° would normally be classified as oleophobic. As this term implies, oil is usually expected to be unable to adhere to an oleophobic surface. However, it is shown herein that there are some surfaces to which oil can adhere, when submerged in an aqueous phase. Some surfaces to which oil can adhere with a contact angle greater than 90° are heterogeneous, varying in composition or in surface roughness.

There have been a few reports of surfaces which allow oil to adhere with a contact angle greater than 90° whilst the surface is submerged in an aqueous phase. One is Chen et al Soft Matter vol 6 pages 2707-2712 (2010) which discloses a surface coated with poly(N-isopropylacrylamide). At 40° C. this provided an oleophobic surface when it was under water. Small droplets of an oil phase were retained on the surface and displayed contact angles of about 127°. The authors reported, consistently with previous findings, that this surface displayed considerable roughness. Liu et al Langmuir vol 26 pages 3993-3997 (2010) observed that oil droplets on a film of a conducting polymer, namely polypyrrole, displayed a contact angle of about 117° when submerged in an aqueous electrolyte solution

It does not appear to have been recognized that such a contact angle imposes a constraint on droplet size. An oil droplet adhering to a surface is subject to force attaching the droplet to the surface, arising from interactions between the surface and the oil where they are in contact with each other. The droplet may also be subject to force tending to remove the droplet from the surface, notably buoyancy if the droplet has lower specific gravity than the aqueous phase. Force from buoyancy to remove a droplet is proportional to the volume of the droplet while force to adhere a droplet is proportional to the area of contact with the surface.

Consequently as droplet size increases, the force of buoyancy to detach a droplet will increase more rapidly than force to adhere the droplet to the surface. Eventually, as size increases, force to detach must overtake force to adhere. This imposes an upper limit on the size of droplet which can remain adhering to the surface. Growing droplets may also be pulled from the surface or broken up by other forces for instance the force which the flow of liquid over a surface will apply force to droplets adhering to the surface.

Because small droplets can adhere to the surface but cannot coalesce to the point of forming a film, and because droplet coalescence has an upper limit, the surface can be used to collect small droplets which are hard to remove from water without the surface becoming completely coated with oil which could in turn lead to it becoming inoperative.

In some embodiments of treatment process, coalescence of small droplets collected on the surface may be allowed to proceed continuously, with small droplets growing into large droplets which spontaneously detach from surface. The larger droplets can then be separated from water more easily than the small droplets which were originally present. Thus a treatment process may bring about separation of oil droplets, or coalescence of oil droplets to a larger size which can be separated by other equipment, or some combination of the two.

For instance, a treatment process might be applied to a saline aqueous solution containing oil droplets smaller than 30 micrometres diameter. These will adhere to a surface as discussed above and the adhering droplets will coalesce. Eventually droplets will grow too large to continue to adhere. Droplets which spontaneously release from the surface would be larger, perhaps having a diameter of 300 micrometers or more. These would separate through buoyancy more rapidly than smaller droplets. Alternatively these could be removed more easily than smaller droplets in a further stage of mechanical separation.

A heterogeneous surface with areas of different surface energy will give an irregular boundary to the area of contact between an adhering droplet and the surface. Upon release of a droplet, separation of the oil droplet from surface will begin at the higher energy, hydrophilic regions of the surface.

A further possibility is that the surface changes its affinity for oil in response to an external stimulus, going to a state in which affinity for oil is reduced and oil droplets adhering to the surface are released.

A treatment process may then comprise allowing oil droplets to adhere followed by applying the external stimulus to cause release of oil droplets. The droplets may grow to a larger size before release, or may be concentrated by accumulation on the surface and release of accumulated droplets, or both of these may take place.

In the case of a surface which is subdivided into areas with differing affinity for oil, change in affinity may be brought about by changing some of the areas of the surface. For instance hydrophobic areas of the surface might change to become more hydrophilic while other areas do not change.

There are various possibilities for an external stimulus to bring about change in affinity for oil droplets. These include temperature, pH of the aqueous phase, electrolyte concentration in the aqueous phase and applied electrical potential. The paper by Liu et al mentioned above discloses that the polypyrrole film is responsive to applied electrical potential bringing about a redox reaction. Application of a negative voltage converted the polypyrrole film to a state such that, while it was immersed in an aqueous electrolyte solution, oil droplets in contact with it displayed a contact angle of 149° and did not adhere to the surface.

The paper by Chen et al mentioned above discloses a surface which is responsive to temperature. Cooling the surface through its lower critical solution temperature converts it to a smooth and hydrophilic surface on which oil droplets display a contact angle of slightly over 150° and do not adhere.

We have found that suitable surfaces can be formed by attaching a layer of molecules to the surface of a supporting substrate. A wide range of materials may be used as the substrate but we envisage that a particulate material can be used and then packed into a bed through which the water with small oil droplets entrained in it is directed. Silica in the form of sand grains may be used. Covalent bonding to silica can be accomplished by reactive silicon compounds which attach to silica by forming Si—O—Si bonds.

It is also possible that the substrate is a planar surface rather than the uneven surface of a particulate material. The surface needs to have a chemical nature which permits covalent attachment, for example through Si—O—Si bonds.

In embodiments, a surface to which oil droplets will adhere may be provided by a polymer brush, that is to say a surface with polymer chains adhering to the surface and extending out from it. A polymer brush may be prepared by reacting an initiator with a solid substrate and then using atom transfer radical polymerization to polymerise polymer chains of uniform length onto the initiator.

Subdividing a surface into areas of differing characteristics may be commenced by a process of printing a pattern onto a substrate or etching a pattern into a substrate, with the pattern having small dimensions, for instance providing individual areas which are no more than 50 nm across. The substrate may be subjected to chemical reaction after it has been divided into heterogeneous areas by the printing or etching process.

We have found that a heterogeneous surface with areas of differing surface energy, and to which oil droplets will adhere while submerged in water or aqueous solution, can have some areas provided by polymer brush and some areas provided by another material. This other material may serve as blocking agent and prevents formation of polymer brush on these areas. The properties of the overall surface and its affinity for oil droplets can be controlled by controlling the relative proportions of the polymer brush areas and the block areas in between. The formation of these areas may begin by treating a substrate with an initiator of polymer brush mixed with a blocking agent using the relative amounts of these materials to control the proportions of polymer brush and blocked areas between.

The blocked areas which are not polymer brush may be so hydrophilic that oil droplets would not adhere to a surface formed only by the blocking material.

Formation of the heterogeneous surface may begin by treating a substrate with a mixture of two reagents which bind to the substrate. One, which may be in a minority proportion, perhaps 20% by weight or less, serves as an initiator onto which a polymer brush can be attached. The other reagent blocks binding of the initiator to the substrate and provides, possibly after a further step of chemical reaction, the areas of the surface between the polymer chains of the brush. Control of the overall affinity for oil may be brought about through choice of the proportions of these two reagents.

Embodiments of treatment process may be carried out underground to separate small oil droplets from an aqueous phase which may itself be the product of downhole mechanical separation of oil and water flowing together from an oil reservoir.

Embodiments of chemistry for use in making surfaces to which oil droplets can adhere will now be described further and exemplified and apparatus incorporating such surfaces will also be described by way of example, in the following text and with reference to the drawings. It should be appreciated that the various features and possibilities referred to herein and illustrated may be used separately or in any operable combination and/or replaced with variations which also deliver the intended functionality.

### BRIEF DESCRIPTION OF THE DRAWINGS

FIGS. 1, 2 and 3 show chemical reactions to apply a monolayer to a substrate surface;

FIGS. 4 and 5 show chemical reactions to modify the monolayers applied in FIGS. 1 and 2;

FIG. 6 shows an oil droplet above a surface, for testing droplet adhesion;

FIG. 7 shows the droplet brought into contact with the surface;

FIG. 8 shows a droplet adhering to the surface;

FIG. 9 shows a droplet on a surface with a contact angle θ which is greater than 90°;

FIG. 10 shows a chemical reaction to form a temperature sensitive polymer brush;

FIG. 11 shows the formation of a heterogeneous surface, parts of which are a temperature sensitive polymer brush;

FIG. 12 shows a succession of stages as more oil is added to a droplet adhering to a polymer brush under water;

FIGS. 13 and 14 show two droplets side by side on a surface;

FIG. 15 shows a chemical reaction to form a pH sensitive polymer brush;

FIG. 16 diagrammatically illustrates a possible arrangement for removal of oil droplets downhole;

FIG. 17 is an enlarged view of part of the apparatus of FIG. 16; and

FIG. 18 diagrammatically illustrates separating equipment at a well head.

### EXAMPLE 1

### Deposition of Monolayers

A number of experiments were carried out in which monolayers of organic compounds were applied to 100 mm diameter silicon wafers as substrate. These silicon wafers were cleaned and oxidized using an air plasma before use as in Brown et al in Eur. Polym. J. vol 41 pages 1757-1765 (2005) so that they had hydroxyl groups on their surface. Three reagents which contained trialkoxy silyl groups were reacted with the silicon substrates. These were:

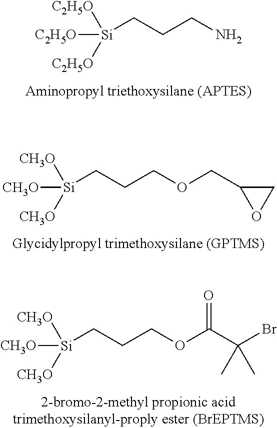

In each case, using a similar procedure to that given by Brown et al in the paper mentioned above a freshly cleaned silicon wafer was placed in a dry dish and covered with a solution of the trialkoxysilyl compound (10 microliter) in toluene (50 ml) to which triethylamine (3 microliter) was added. The wafer was left in this mixture for 18 hours at room temperature and then removed and washed with toluene, acetone and absolute ethanol.

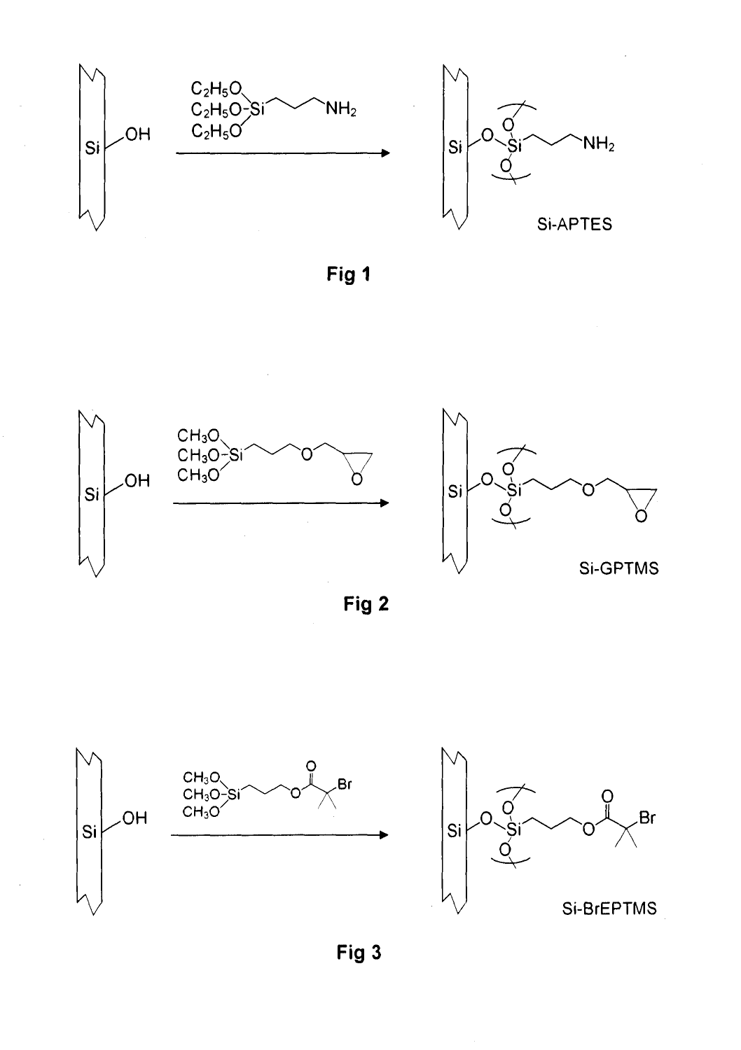

The trialkoxysilicon-containing reagent forms covalent Si—O—Si bonds to the silicon wafer surface and also to adjacent residues of the reagent so that the silicon wafer is covered with a monolayer of residues of the reagent. These reactions are shown in FIGS. 1, 2 and 3. The wafers with monolayers on them are conveniently referred to as Si-APTES, Si-GPTMS and Si-BrEPTMS respectively.

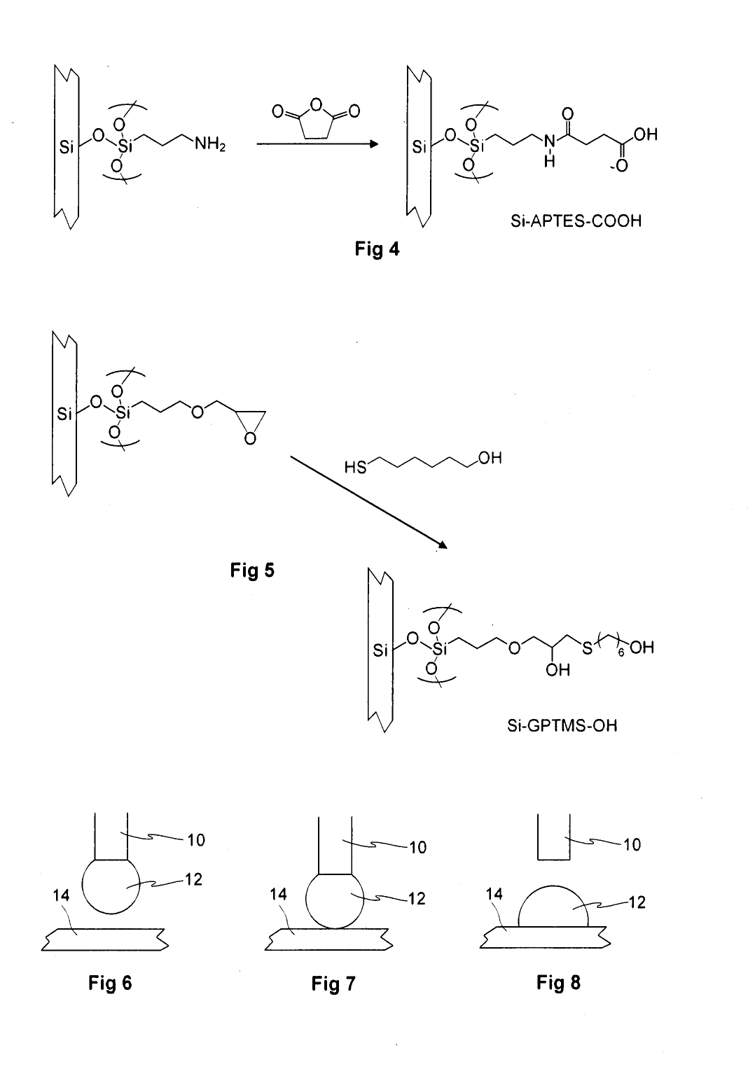

In two instances the silicon wafers with a monolayer applied to them were reacted further as shown in FIGS. 4 and 5. The amino groups of APTES residues were reacted with succinic anhydride, as described by An et at in J. Colloid Interf. Sci. vol 311 pages 507-513 (2007) to form a monolayer terminating in carboxylic acid groups (referred to as Si-APTES-COOH). The reaction was carried out in dimethyl formamide at room temperature for 24 hours. The epoxy groups of the GPTMS residues were reacted with 6-hydroxy hexanethiol using a procedure described by Toworfe et at in Biomaterials vol 27 pages 631-642 (2006) to form a monolayer terminating in hydroxyl groups (referred to as Si-GPTMS-OH). The reaction was carried out in water at room temperature for 20 hours.

The hydrophilic nature of all five monolayers was demonstrated by observing the contact angle, in air, of a water droplet placed on the surface of the coated silicon wafer. These contact angles are included in the table below.

Underwater adhesion of oil droplets (either decane or hexadecane) was examined with the coated silicon wafer immersed, in a horizontal position, in de-ionised water at 20° C.

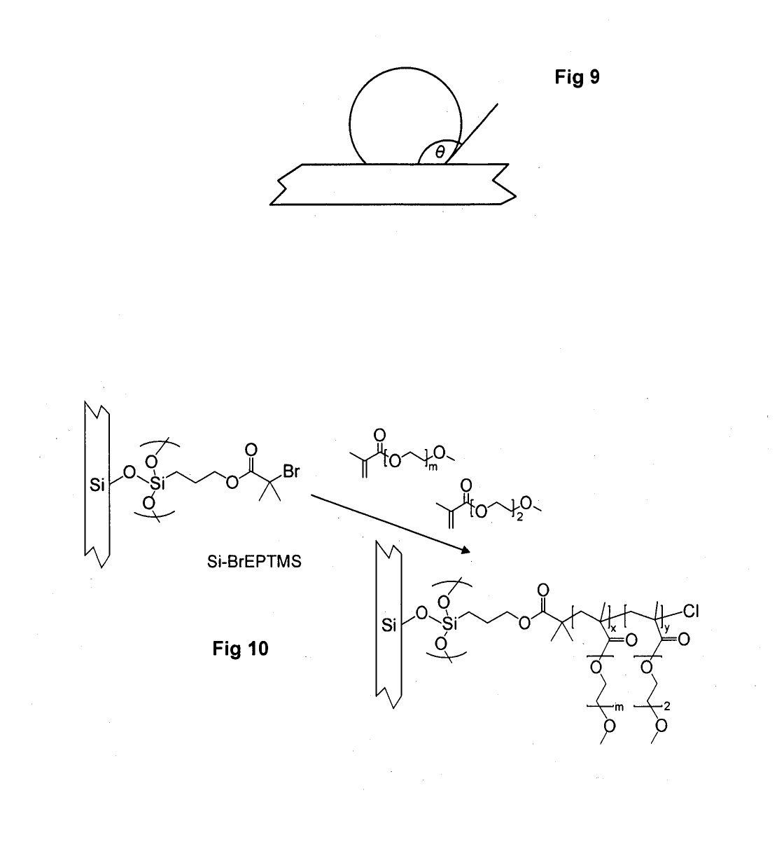

As shown in FIG. 6, a hollow needle 10 of 0.81 mm outer diameter, bearing a droplet 12 of oil with a volume of 2 microliter on the tip of the needle 10, was positioned above the wafer 14. The needle was lowered towards the wafer 14 until the droplet just touched the surface as shown by FIG. 7. After approximately 40 seconds the needle was raised again. If the droplet adhered to the surface, the droplet remained on the surface, as illustrated by FIG. 8. If the droplet did not adhere, it rose again with the needle, thus reverting to the position shown in FIG. 6. When droplets adhered, contact angles were determined from digital photographs. As shown by FIG. 9, the contact angle is the angle θ subtended between the surface in contact with a droplet and a tangent to the droplet at the point of contact. The results of these tests were the same with decane and hexadecane and are set out in the following table which also shows the water contact angles in air.

| Wafer and | Water contact angle | Underwater adhesion of oil |
|---|---|---|
| monolayer | in air | droplet (& contact angle) |
| Si-APTES | 54° | Yes: contact angle approx 107° |
| Si-GPTMS | 45° | No |
| Si-BrEPTMS | 66° | Yes: contact angle approx 103° |
| Si-APTES-COOH | 46° | No |
| Si-GPTES-OH | 42° | No |

Thus oil adheres to the more hydrophobic surfaces provided by Si-APTES and Si-BrEPTMS. Tests of underwater oil adhesion at 60° C., using both decane and hexadecane, gave very similar results to those at 20° C.

### EXAMPLE 2

The procedure of Example 1 was repeated using four more reagents which included trialkoxy silyl groups. Each of these reagents included a hydrophobic group which became attached to the silicon wafer. The reagents were:

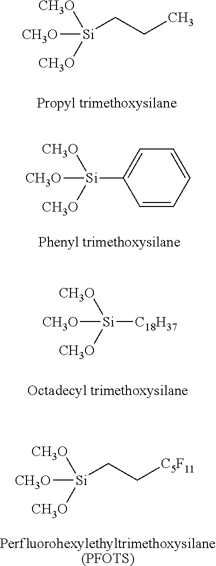

As in Example 1 a water droplet was placed on the surface of each coated silicon wafer, with the wafer exposed to air, and the contact angle was noted.

Underwater adhesion of decane droplets was examined as in Example 1 with each coated silicon wafer immersed, in a horizontal position, in de-ionised water at 20° C. The following results were obtained

| | | Underwater adhesion of oil |
|---|---|---|
| Monolayer | Water contact angle in air | droplet (& contact angle) |
| Si-propyl | 50° | No |
| Si-phenyl | 60° | No |
| Si-octadecyl | 81° | No |
| Si-PFOTS | 113° | Adheres; contact angle 34° |

In the case of the Si-PFOTS wafer which had very hydrophobic fluorinated alkyl groups in the monolayer, successive further droplets of decane were added directly onto the upper surface of the droplet already adhering to the wafer surface. As the droplet on the surface grew in size, it spread out over the surface with the contact angle remaining at approximately 34°.

### EXAMPLE 3

### Formation of Temperature Sensitive Polymer Brush

A polymer brush was polymerized onto a wafer bearing a monolayer of residues of 2-bromo-2-methyl propionic acid trimethoxysilanyl propyl ester (BrEPTMS). These residues served as an initiator for polymerization by atom transfer radical polymerization (ATRP), a method of polymerisation which leads to polymer chains of uniform length extending from the initiator sites.

The monomers for this ATRP were a mixture of

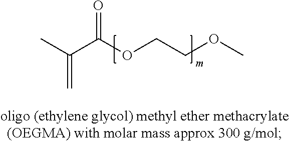

and di(ethylene glycol)methyl ether methacrylate (MEO₂MA) which has the same general formula but m=2. Polymerisation is a reaction of the methacrylate groups to form a polymer chain of aliphatic carbon atoms with the ethoxy groups of the monomers in side chains. The procedure for such polymerization, as given in the supplementary information to Jonas et al in Macromolecules vol 40 pages 4403-4405 (2007), was as follows.

For a MEO₂MA:OEGMA molar ratio of 90:10, 16.94 g of MEO₂MA (85.5 mmol) and 2.85 g of OEGMA (9.5 mmol) were dissolved in a mixture of water (30 ml) and CH₃OH (15 ml) in a round-bottom flask sealed with a rubber septum. Bipyridyl (5 mmol, 782 mg) and Cu(II)Cl₂ (0.16 mmol, 21.5 mg) were added to this solution, which was stirred and degassed with a stream of nitrogen for 30 min. Cu(I)Cl (1.6 mmol, 158.5 mg) was then added quickly to the solution. The solution was stirred and degassed for 30 further min. Meanwhile, the Si-BrEPTMS wafers were sealed into Schlenk tubes and were degassed (4 vacuum/N₂ filling cycles). The polymerization solution was then syringed and quickly transferred to the Schlenk tubes. After various polymerization times at room temperature under an overpressure of nitrogen in the absence of stirring, the samples were removed, washed with water then absolute ethanol, dried with a stream of N₂ and stored under nitrogen. The reaction is shown as FIG. 10.

As explained by Jonas et al, such polymers exhibit a lower critical solution temperature (LCST) in water which can be controlled by the proportions of the monomers. In this example the monomers were used in a ratio of 90:10 to give a polymer brush with an LCST in water of about 40° C. Above this temperature the polymer behaves as a water-insoluble material and the polymer chain is folded into a compact, generally hydrophobic globular structure. Below the LCST, the polymer chains can extend out into the aqueous phase and are more hydrophilic.

Polymerisation was carried out under conditions to form a polymer brush thickness of 19±1 nm. The procedure was also repeated using a shorter reaction time to form a polymer brush of 13±2 nm.

The underwater adhesion of oil droplets to the polymer brushes on the wafers was examined using the procedure described in Example 1 referring to FIGS. 6 to 8. It was observed with both brush thicknesses that oil droplets adhered to the surfaces at 60° C. and also at 20° C. with a contact angles greater than 120°. The contact angles were slightly greater at 20° C. than at 60° C.

### EXAMPLE 4

### Formation of a Heterogeneous Surface

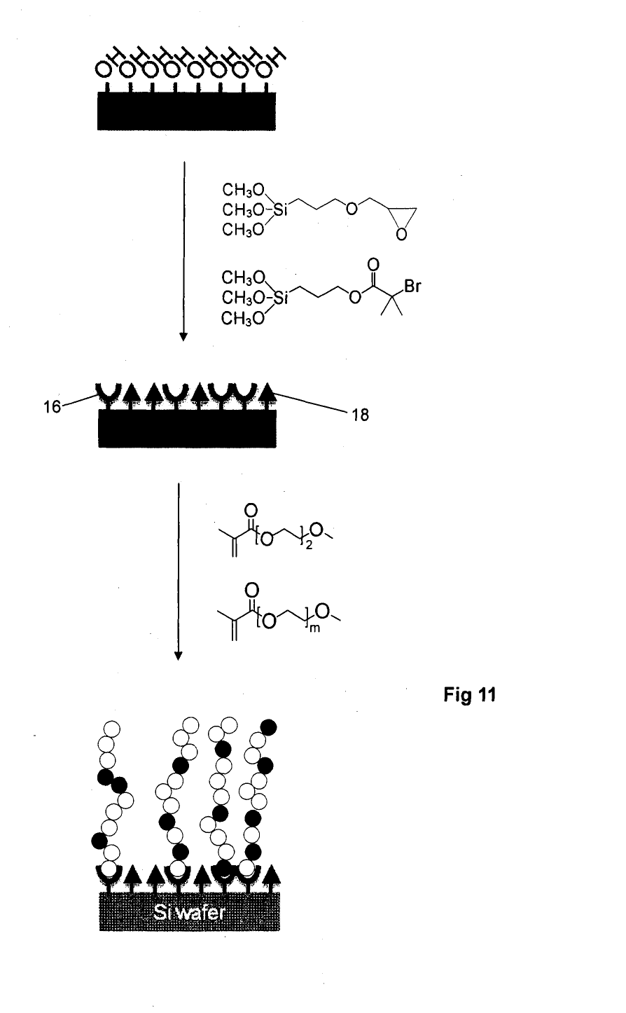

Monolayers were applied to silicon wafers, as in previous examples, using a mixture of BrEPTMS and GPTMS in various ratios. This is illustrated by the upper portion of FIG. 11. The first stage using the mixtures of BrEPTMS and GPTMS led to a mixed layer on the silicon wafers. This layer contained BrEPTMS residues, depicted as open cups 16 in FIG. 11 which provide ATRP initiator sites and GPTMS residues depicted as triangles 18 which provide hydrophilic surface areas but do not initiate ATRP. Polymer brushes were then formed by polymerization onto the BrEPTMS residues using the same monomer mixture as in Example 2 above. As illustrated at the foot of FIG. 11, this procedure led to polymer brushes which were less dense than those in the previous Example. The polymer chains of the brush contained residues of MEO₂MA depicted as open circles and residues of OEGMA depicted as filled circles. The polymer chains were spaced apart by areas in which the surface of the wafer was covered with GPTMS residues.

At 60° C., which is above the LCST the surface on the silicon wafer is heterogeneous. It has hydrophilic areas provided by the GPTMS residues and hydrophobic areas provided by the globular polymer chains of the brush. At 20° C., below the LCST, the surface is still heterogeneous but the polymer brush chains are able to extend out into the aqueous phase and are more hydrophilic than the globular state at 60° C.

Polymerisation was carried out to give brush thicknesses of 19±1 nm and 13±2 nm. Control of brush thickness controls properties: the longer chains in the thicker brush provide more hydrophobicity at 60° C. Adhesion of oil droplets was again tested using the procedure described in Example 1 referring to FIGS. 6 to 8. The results with 19 nm brushes (including those from the previous Example with BrEPTMS only) were

| GPTMS:BrEPTMS ratios | | | | |
|---|---|---|---|---|
| BrEPTMS | | | | |
| only | 5:1 | 10:1 | 20:1 | 40:1 |

| | | |
|---|---|---|
| 19 nm at 20° C. | adheres | does not adhere |
| 19 nm at 60° C. | adheres | adheres, contact angle about 115° |

In the case of 13 nm brushes, multiple tests were carried out, observing the behaviour of three separate droplets of decane on each of five wafers made with the same ratio of BrEPTMS and GPTMS. It was observed that there was some variation in behaviour from one droplet to another, possibly attributable to small variations in droplet size. However, there was a clear difference in behaviour at 20° C. and 60° C. The percentages of droplets which adhered to the surface were:

| | GPTMS:BrEPTMS ratios | | | | |
|---|---|---|---|---|---|
| | all BrEPTMS | 5:1 | 10:1 | 20:1 | 40:1 |
| 13 nm at 20° C. | 50% | 10% | 35% | 25% | 25% |
| 13 nm at 60° C. | 100% | 90% | 80% | 62% | 58% |

### EXAMPLE 5

As in the preceding Example, a monolayer was applied to a silicon wafer, using a mixture of BrEPTMS and GPTMS in 5:1 ratio and a polymer brush with a thickness of 12±2 nm was formed on the monolayer. Underwater adhesion of 5 microlitre decane droplets was examined with the coated silicon wafer immersed, in a horizontal position, in de-ionised water at 60° C.

When a single droplet was placed on the wafer it adhered with a contact angle of approximately 122°. Successive further droplets of decane were then deposited onto upper surface of the droplet already on the wafer so that they added to this droplet. As the droplet on the wafer was made larger it did not spread out on the wafer surface. It could be seen to be lifted by buoyancy and eventually, with increasing size of the droplet, a point was reached at which most of the droplet detached from the wafer and floated away, leaving only a small amount of decane on the wafer surface.

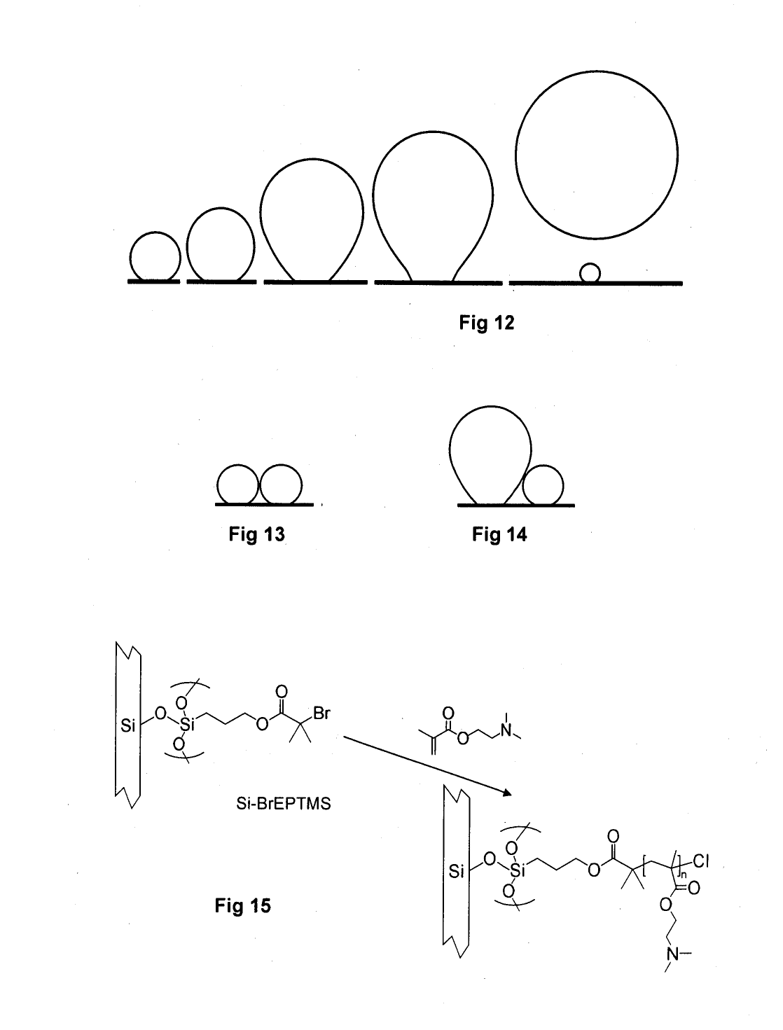

This succession of stages is illustrated in FIG. 12, progressing from left to right.

When a droplet was placed on the wafer and a second droplet was placed beside it, the two droplets did not coalesce but remained separate with a gap between the areas of contact with the wafer as shown in FIG. 13. If one droplet on the surface was enlarged by adding more oil to it, the droplets still did not coalesce, as shown in FIG. 14, even though they touched each other above the wafer surface.

### EXAMPLE 6

### Effect of Salt Concentration

Si-GPTMS wafers, in which the silicon is covered with a monolayer of residues of glycidyl groups, were prepared as in Example 1 and tested for adhesion of decane droplets by the procedure described with reference to FIGS. 6 to 8 both with the wafers immersed in water and with the wafers immersed in 3.5 wt % sodium chloride solution.

It was observed that all decane droplets adhered to the monolayer surface, with contact angle of approx 133° when immersed in sodium chloride solution but no droplet adhered when immersed in de-ionised water. This indicates that it would be possible to adsorb oil droplets onto such a surface from suspension in a downhole brine, or from suspension in sea water, and subsequently displace the adsorbed oil droplets by exposing the adsorbed droplets to fresh water.

### EXAMPLE 7

Wafers were prepared as in Example 4, using a 5:1 ratio of GPTMS to BrEPTMS. The wafers were immersed in water which was cycled repeatedly between 20° C. and 60° C. Each time a stable temperature was reached the adhesion of droplets was tested using six decane droplets per wafer. It was observed that at 60° C. at least 75% of the droplets adhered to surface when applied from a needle, but at 20° C. no more than 25% of droplets adhered the surface and usually less than 25%. This reversibility was maintained for eight cycles between 20° C. and 60° C.

### EXAMPLE 8

A monolayer was applied to silicon wafers, as in Example 4 but using a mixture of PFOTS and BrEPTMS in 40:1 ratio. The resulting layer contained fluorinated octyl groups which provide hydrophobic areas and do not initiate ARTP and also BrEPTMS residues which do provide ATRP initiator sites. Underwater adhesion of decane to such a layer was observed as described in Example 1 referring to FIGS. 6 to 8. The droplet showed a contact angle of approximately 37°. When additional decane was added to the droplet on the wafer, the droplet spread out, maintain the same contact angle.

Polymer brushes having a thickness of 16±2 nm were formed on wafers with this monolayer by polymerization onto the BrEPTMS residues using the monomer mixture of Examples 3 and 4 above. Underwater adhesion of decane was investigated as described previously.

At 20° C. droplets adhered with a contact angle of approximately 89°. When additional oil was added to the droplet already on the surface, the growing droplet spread out on the surface, maintaining the contact angle of approximately 89°.

At 60° C. droplets adhered, but with a lower contact angle of approximately 52°. Again, when additional oil as added to the droplet already on the surface, the growing droplet spread out on the surface, maintaining the same contact angle of approximately 52°.

### EXAMPLE 9

### Formation of pH Sensitive Polymer Brush

A polymer brush was polymerized onto a wafer bearing a monolayer of residues of 2-bromo-2-methyl propionic acid trimethoxysilanyl propyl ester (BrEPTMS). These residues served as an initiator for polymerization. The monomer was

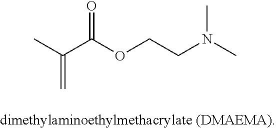

As illustrated by FIG. 15, polymerisation of DMAEMA onto the layer of BrEPTMS residues by ATRP formed a polymer brush of polyDMAEMA having a thickness of approximately 10 nm. See Zhang et al in J. Colloid Interface Sci vol 301 pages 85-91 (2006) and Tan et al in Soft Matter vol 7 pages 7013-7020 (2011).

The adhesion of 2 microliter droplets of decane was tested as described in Example 1 referring to FIGS. 6 to 8 above, with the wafer submerged in a sequence of solutions of varying pH. The solutions and results are given in the following table:

| | | |
|---|---|---|
| 10 mM hydrochloric acid | pH 2 | does not adhere |
| 10 mM sodium hydroxide | pH 12 | adheres, contact angle approx 140° |
| 10 mM hydrochloric acid | pH 2 | does not adhere |
| 10 mM sodium bicarbonate | pH 9 | adheres, contact angle approx 140° |
| 10 mM hydrochloric acid | pH 2 | does not adhere |
| deionised water | pH 6.5 | adheres, contact angle approx 140° |

It is apparent from these results that the droplet ceases to adhere when the brush is protonated under acidic conditions, but does adhere under neutral or alkaline conditions when the brush is not protonated and less hydrophilic. Moreover, these properties were maintained while cycling the brush between protonated and unprotonated states.

### EXAMPLE 10

Wafers with a DMEMA polymer brush of approximately 11 nm thickness were prepared as in the previous Example. A 5 microliter droplet of decane was deposited on a wafer while it was submerged in deionised water at pH6.5. The droplet adhered to the wafer surface.

The needle was lowered onto the droplet and then raised again as an attempt to pull the droplet from the wafer surface. The droplet was stretched upwardly as the needle was raised, but then the droplet separated from the needle and remained on the wafer surface. This demonstrated that the droplet was strongly attached to the wafer surface.

The solution was then acidified to approx pH 1 by adding hydrochloric acid and the needle was again lowered onto the droplet and raised again. The droplet was again observed to stretch upwardly as the needle was raised, but then the droplet separated from the wafer surface and remained attached to the needle. Thus under these acidic conditions the attachment of the droplet to the surface was weaker.

It was found that under these acidic conditions, droplets could be dislodged from the surface by using a suction pipette to creating movement of the solution near the droplet whereas similar movement of the solution did not dislodge a droplet underwater at pH 6.5.

The procedure was repeated, with the variation that after depositing decane on the wafer surface while submerged beneath deionised water, additional decane was added to the droplet. The droplet still remained on the wafer surface when the needle was raised. When hydrochloric acid was added, the contact angle spontaneously increased from about 92° to about 124° and the droplet was removed from the wafer surface with the needle.

### EXAMPLE 11

A wafer with a DMEMA polymer brush of approximately 11 nm thickness was prepared as in Example 9 and a 5 microliter droplet of decane was deposited on the wafer while it was submerged in deionised water at pH6.5. Additional decane was then added into the droplet. As the volume of decane in the droplet was increased, it was observed to be lifted by buoyancy and eventually most of the droplet detached from the wafer surface and floated away leaving a small decane droplet behind on the surface, just as illustrated in FIG. 12.

The procedure was repeated, acidifying the water after depositing the first 5 microliter droplet of decane on the wafer surface. It was possible to add more decane into the droplet on the wafer surface after acidifying, but as the volume of decane in the droplet was increased, a point was reached at which the enlarged droplet remained attached to the needle and detached from the wafer surface leaving almost no decane behind.

To demonstrate that the surface is reusable, the wafer was rinsed with water which had been acidified, then rinsed with deionised water and again submerged in deionised water at pH 6.5. A 5 microliter droplet of decane was adhered to the surface and the procedure was repeated as before.

### EXAMPLE 12

An experiment was carried out using tap water and an oil which was aliphatic hydrocarbons of mixed chain length. A wafer with a DMEMA polymer brush of approximately 16 nm thickness was prepared as in Example 9 and a 5 microliter droplet of oil was deposited on the wafer while it was submerged in tap water. The droplet was seen to be attached securely and was not removed by contact with the needle. The water was acidified by dropwise addition of hydrochloric acid. As pH was reduced, adherence of the droplet was tested by contact with th needle. When the pH had been reduced to pH 4.1 the droplet could be removed by contact with the needle.

This procedure was repeated with varying concentrations of sodium chloride dissolved in the tap water. It was again observed that a droplet of oil would be attached securely to the wafer before acid was added but easily removed after acidifying. With increasing salt concentration the solution had to be made more acid in order that an oil droplet could be removed with the needle. These results are shown in the following table. 600 mM NaCl is a salinity similar to that of sea water.

| Solution in which droplet | | Droplet removed with |
|---|---|---|
| applied. pH near neutral | pH after adding acid | needle |
| water | 4.1 | yes |
| 150 mM NaCl | 3.7 | yes |
| 600 mM NaCl | 2.2 | no |
| 600 mM NaCl | 1.8 | yes |
| 600 mM NaCl | 1.4 | yes |

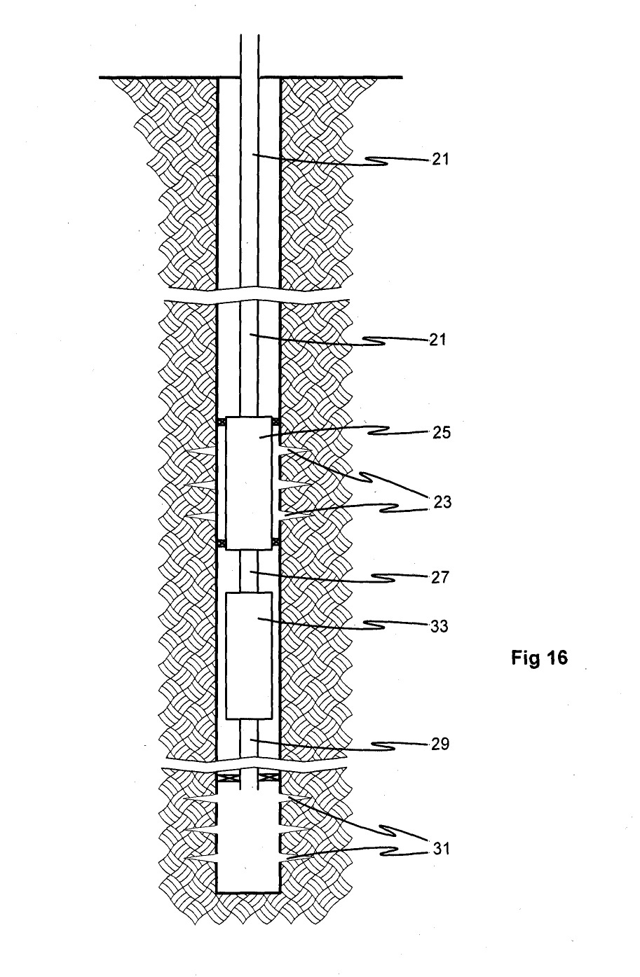

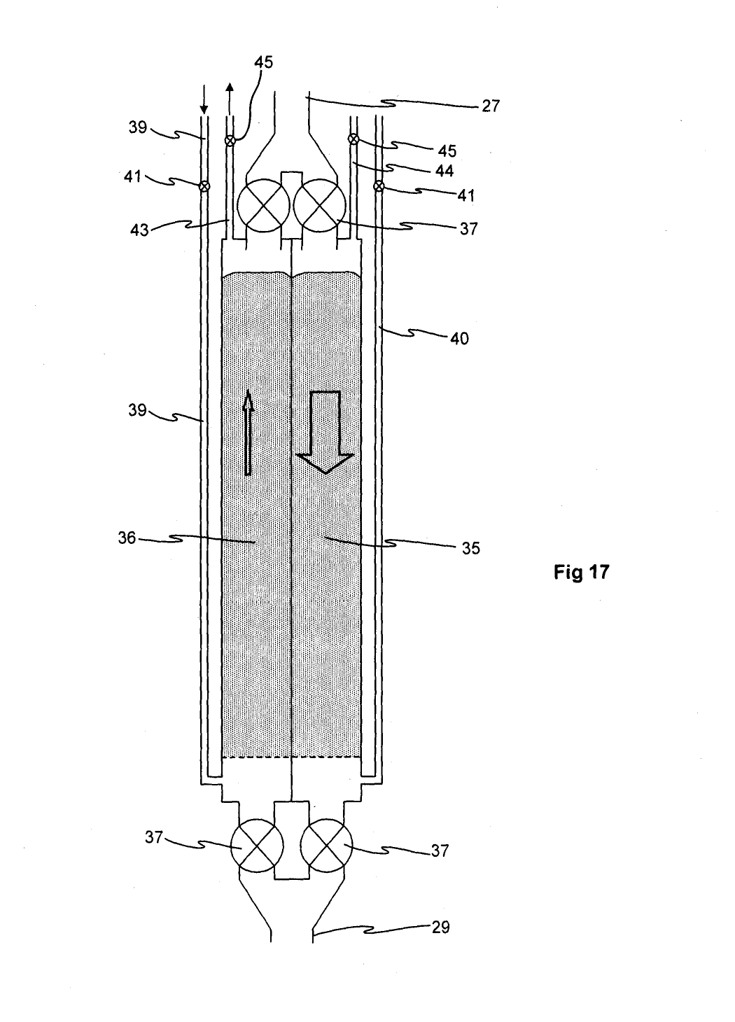

FIGS. 16 and 17 illustrate an application of the treatment process to the separation of oil and connate water below ground. FIG. 16 shows a well bore which penetrates an oil reservoir. The well bore is lined with casing within which production tubing 21 rises to the surface. A mixture of oil and water enters the casing through perforations 23 and a separator 25 incorporating a hydrocyclone separates this inflow into a flow of oil which goes upwards within the production tubing 21 and a flow of water descending in tubing 27, 29 towards further perforations 31 through which it is injected into the surrounding formation, below the oil reservoir.

Water coming down tubing 27 from the separator 25 contains small droplets of oil which have not been removed. Typically these are 10 to 30 nm in diameter. The water is made to flow through a unit 33 to remove these droplets and this unit 33 is shown at a larger scale in FIG. 17.

The unit 33 has two similar sections shown positioned side by side although other geometries such as one above the other is also possible. These sections of the unit 33 contain beds 35, 36 of sand grains completely coated with a layer which allows oil droplets to adhere with a contact angle in the range 120 to 150° and to detach in response to an external stimulus. This coating layer may be formed from chemical compositions as discussed in the examples above. It may, for instance, release the oil droplets when contacted with dilute hydrochloric acid to change pH or contacted with fresh water containing a lower quantity of dissolved salts than the connate water from the reservoir.

Valves 37 above and below the beds 35, 36 are operated to direct the flow of separated water from tubing 27 to pass through the beds 35, 36 alternately, one bed serving to remove oil droplets while the other bed is being regenerated. In FIG. 17 arrows indicate water flow through the right-hand bed 35 where small droplets of water adhere to the coated sand so that oil is removed before the water enters the tubing 29 below the bed.

To regenerate the other bed 36, liquid (for example dilute acid solution or fresh water) is supplied from the surface by pipe 39 which descends the well bore in the annulus between the production tubing 21 and the casing. It passes through control valve 41 and rises through the bed 36. The liquid outflow from this bed 36 leaves through pipe 43 and valve 45. When the bed 35 is regenerated, pipes 40 and 44 function in the corresponding way to 39 and 43.

The oil droplets which adhere to the coated sand in the beds 35, 36 while the water entering from tubing 27 is passing through one or other of the beds may grow through coalescence while adhering to the coated sand of the bed. When a bed 35,36 is regenerated, the released oil travelling up pipe 43 or 44 will be at a much higher concentration than in the incoming flow from tubing 27 and therefore will be able to coalesce further.

Because the oil rising in the pipes 43 or 44 from the bed which is being regenerated will have larger droplet size, these pipes 43, 44 may possibly return the effluent flow from regeneration of a bed 35 or 36 to an inlet region of the separator 25. Alternatively these pipes 43, 44 may rise to the surface for the mixture of oil and water from the regeneration of the bed to be separated and disposed of at the surface. It will be appreciated that even if the effluent from bed regeneration is returned to the surface, the volume returned to the surface will be much less than the volume of water which has been separated from oil and injected back into underground formation through perforations 31.

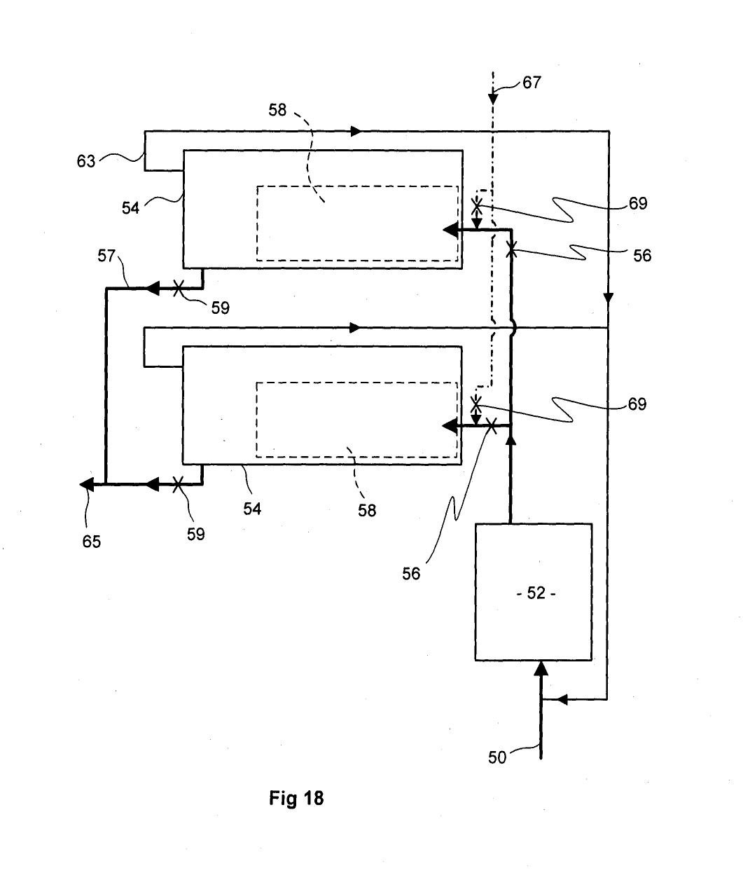

FIG. 18 shows equipment for the treatment of produced water at a wellhead. Incoming produced water, entering at 50 and containing oil is passed through a conventional oil water separator 52 which removes the larger oil droplets. The water from this separator 52 is then admitted to units 54 through valves 56. The water flows through the units and most of it leaves by outlet lines 57 including valves 59. Each unit 54 contains a particulate bed or convoluted structure 61, diagrammatically shown by a rectangle with broken lines. The particulate material or structure has a polyDMEAMA brush on its surface. At the pH and salinity of the flowing water the small oil droplets in the water adhere to this surface and are retained unless other droplets collide with them and the droplets grow large enough to detach spontaneously as illustrated earlier by FIG. 12. As flow moves towards the outlet lines 57 such larger oil droplets float upwards and are removed in a layer of water from the upper part of the flow which is drawn off along recycle lines 63 and returned to the separator 52.

The units 54 operate alternately. Flow from the separator 52 is directed through one unit. Small oil droplets accumulate on the surface within its bed or structure 61. Some of the small droplets grow as other oil droplets add to them and eventually detach, but float upwards and are returned to the separator 52 along recycle line 63. Most of the produced water, now freed from small oil droplets leaves by an outlet line 57 and is discharged as indicated at 65.

Periodically, the inlet and outlet valves 56, 59 are operated to switch the flow to the other one of the units 54. The unit which has just ceased operation is then regenerated by pumping in a weak solution of hydrochloric acid in fresh water from a supply line 67 through a valve 69. Under these acidic and less saline conditions the DMEAMA brushes do not retain the oil droplets which have adhered to the surface in the bed or structure 61. The oil droplets are dislodged by the flow and are returned to the separator 52 along recycle line 63.

1. A treatment process for water or aqueous solution which contains oil droplets, the process comprising bringing the water or aqueous solution into contact with a surface such that when the surface is submerged in the water or aqueous solution, oil droplets adhere to the surface with a contact angle in a range from 90 to 150 degrees.

2. A process according to claim 1 wherein the surface is subdivided into areas of differing surface energy and affinity for oil and such that when the surface is submerged in an aqueous phase, oil droplets adhere to it.

3. A treatment process for water or aqueous solution which contains oil droplets, the process comprising bringing the water or aqueous solution into contact with a surface which is subdivided into areas of differing surface energy and affinity for oil such that when the surface is submerged in the water or aqueous solution, oil droplets adhere to it.

4. A process according to claim 2 wherein oil droplets adhere to the surface with an irregular boundary to the area of contact.

5. A process according to claim 1 wherein the surface allows adhering oil droplets to coalesce with additional oil and then spontaneously releases droplets larger than a limiting size.

6. A process according to claim 1 wherein areas of the surface reduce their affinity for oil in response to an external stimulus, and the process comprises applying the external stimulus to cause release of droplets adhering to the surface.

7. A process according to claim 6 wherein the external stimulus is temperature, pH of the aqueous phase, electrolyte concentration in the aqueous phase or applied electrical potential.

8. A process according to claim 6 wherein areas of the surface which reduce their affinity for oil in response to an external stimulus are provided by molecules which change their configuration in response to changes in temperature or pH of the surrounding aqueous phase.

9. A process according to claim 1 wherein areas of the surface carry a polymer brush which changes its affinity for oil in response to an external stimulus.

10. A process according to claim 1 wherein the surface is provided by a supporting substrate with attached molecules covering the substrate, and a majority of those molecules provide hydrophilic groups at the exposed surface of the layer.

11. A process according to claim 10 wherein a minority of the molecules attached to the substrate have a polymer brush grafted to them.

12. A process according to claim 1 wherein the surface is provided by a particulate substrate with a covering layer thereon.

13. A process according to claim 1 which is performed underground to separate oil droplets from water from an oil reservoir after an initial mechanical separation of oil from water provides an oil stream containing the oil droplets.

14. A substrate having a layer of molecules covalently attached thereto wherein a minority of the molecules attached to the substrate have a polymer brush grafted to them and a majority of the molecules provide hydrophilic groups at the exposed surface of the layer, between the polymer chains of the brush.

15. A process according to claim 3 wherein oil droplets adhere to the surface with an irregular boundary to the area of contact.

16. A process according to claim 3 wherein the surface allows adhering oil droplets to coalesce with additional oil and then spontaneously releases droplets larger than a limiting size.

17. A process according to claim 3 wherein areas of the surface reduce their affinity for oil in response to an external stimulus, and the process comprises applying the external stimulus to cause release of droplets adhering to the surface.

18. A process according to claim 3 wherein areas of the surface carry a polymer brush which changes its affinity for oil in response to an external stimulus.

19. A process according to claim 3 wherein the surface is provided by a supporting substrate with attached molecules covering the substrate, and a majority of those molecules provide hydrophilic groups at the exposed surface of the layer.

20. A process according to claim 19 wherein a minority of the molecules attached to the substrate have a polymer brush grafted to them.
